(19) United States
(12) Patent Application Publication
(10) Pub. No.: US 2004/0267870 A1
(43) Pub. Date: Dec. 30, 2004

(54) Method of single sign-on emphasizing privacy and minimal user maintenance

(76) Inventors: John Michael Rozmus, Cedar Park, TX (US); Richard Allen Shoobridge, Cedar Park, TX (US)

Correspondence Address: J. MICHAEL ROZMUS, 1809 JOJOBA DRIVE, CEDAR PARK, TX, 78613, US

(21) Appl. No.: 10/607,673

(22) Filed: Jun. 26, 2003

(51) Int. Cl. G06F 15/16

(52) U.S. Cl. 709/200

(57) ABSTRACT

A user may sign-on to multiple Web services with a single passphrase. All of the particular information needed to sign on to each specific Web service is stored for the user in an encrypted form by a Private Single Sign-On (SSO) Web service. This particular information is captured and retrieved automatically. The Private SSO service does not know the unencrypted forms of the user's passphrase or the user's particular information. Thus the user retains a high degree of privacy.

### BACKGROUND

1. Field of the Invention

The present invention relates to computer networking, specifically to the problem of affording secure access for users to World-Wide Web services, while maintaining simplicity and ease of use.

2. Prior Art

Users of the World-Wide Web on the public Internet can now use a multitude of public Web services, including electronic banking, e-mail, retail buying, stock trading, library research, etc. Many useful Web services require that users provide names, passwords, addresses, phone numbers, and other personal information in order to access the services. Numerous single sign-on (SSO) methods have been designed to enable users to remember only one short sequence of personal information in order to gain access to multiple Web services. However, these methods exhibit at least one of two significant deficiencies: required cooperation among multiple Web services or local storage of important private information.

The first of these deficiencies is well illustrated by Microsoft's widely known Passport system. (See “Microsoft .NET Passport Technical Overview”, September, 2001, Microsoft Corporation, [retrieved on May 20, 2003], retrieved from <URL: http://www.si.umich.edu/Classes/540/Placement/MSPassportWhitePaper.doc>.) In this system, multiple Web application services delegate the user authentication function to a centralized Microsoft service. Using an e-mail address and a single passphrase, a user signs on only with the Microsoft service, which authorizes access to each Web application service by sending encrypted messages to the services via the user's computer. (For details of protocol, see “Passport Protocol”, Paul Resnick, [retrieved on May 20, 2003], retrieved from <URL: http://www.si.umich.edu/Classes/540/Placement/PassportProtocol.doc>.)

The Passport system requires that the individual user trust Microsoft to a high degree, because the centralized authentication service could easily be used to construct a detailed profile of an individual's Web service usage. Many users may avoid such a system in order to protect their privacy. Furthermore, each Web application service must support the special Passport protocol. In theory, a Web application service may delegate all authentication of users to Microsoft Passport, but this would mean refusing to do business with users who do not accept Passport. Thus some Web application services continue to maintain their own system of authentication in addition to Passport, complicating their operations. In summary, Microsoft Passport requires Web services to cooperate with Microsoft in a system to identify and authorize the users, which complicates operations and has potential for undesirable loss of user privacy.

A second significant deficiency in the prior art is local storage of important private information, such as usernames and passwords for signing on to multiple Web services. In many current single sign-on methods, this information is stored locally on the individual user's computer or in a file on a private enterprise network. (A typical example, AccountLogon, is described in “About AccountLogon”, Rhodes Software Pty Ltd., copyright 2003, [retrieved on Jun. 11, 2003], retrieved from <URL: http://rhodessw.dezines.com/about.html>.) This requires the user to own and properly maintain a computer or computer network, especially including reliable back-up. It is well known that computer users are often notoriously lax about computer maintenance in general and data backup in particular—especially outside of a well regulated corporate environment. Although the vast majority of consumers may find a wide selection of Web services to be very useful, relatively few of these consumers are willing and able to maintain computers well enough so that they may rely upon them for access to important Web services such as banking, e-mail, stock trading, etc.

### Objects and Advantages

This invention discloses a new method of single sign-on to multiple Web services that is compatible with the present operations of almost all Web services, maintains a high degree of privacy for personal information, and needs very little computer maintenance by users.

### SUMMARY

The present invention is a method of applying personal information in the use of Web services. A new Web service stores and retrieves a user's private information in an encrypted form. After entering a single passphrase, the user may retrieve and decrypt the personal information whenever it is needed to sign on to a Web application service, fill-in repetitive information on a Web order form, retrieve personal medical history, etc. No changes are required for compatibility with the vast majority of existing Web services. The user need only remember the single passphrase and use a standard Web browser to operate the new single sign-on Web service.

### BRIEF DESCRIPTION OF THE DRAWINGS

FIG. 1 illustrates a typical arrangement of computers that would support operation of the invention.

FIG. 2 is a flowchart of a sign-up process for a preferred embodiment of the new single sign-on Web service.

FIG. 3 is a flowchart of a process for recording and storing a user input sequence associated with a particular Web page.

FIG. 4 is a flowchart of a process for retrieving a user input sequence associated with a particular Web page and automatically entering it in that Web page.

FIG. 5 is a flowchart of a process for changing the user's passphrase, which is used for access to the new single sign-on Web service.

### DETAILED DESCRIPTION

### Preferred Embodiment: Structure and Operation

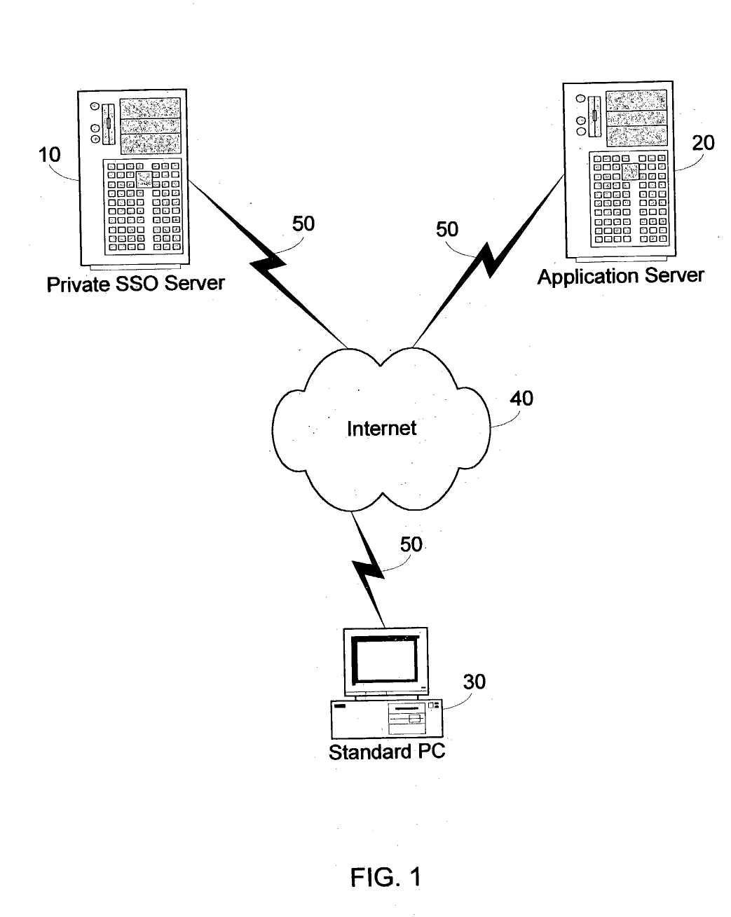

FIG. 1 shows a typical arrangement of computers that would support operation of the present invention. A standard PC 30 provides a user interface and runs client software that provides access to the new Private Single Sign-On (SSO) service. A Private SSO Server 10 runs software that maintains a User Database and a Private Info Database to implement the centralized function of the Private SSO service. An Application Server 20 runs software that implements the centralized function of some Web service desired by a user, such as electronic banking, Web e-mail, online shopping, etc. These three computers use communication links 50 to communicate with one another via the public Internet 40.

FIG. 1 shows only one of many possible computing arrangements that would support the present invention. The elements of the new method are logical steps typically implemented by software interacting with a user. The software running on server 10 and on server 20 may be divided to run on more than two computer servers, or the software might be loaded onto a single server, which would run both the Private SSO and Application functions. The client software running on standard PC 30, which is typically based on an Intel processor and Microsoft Windows operating system, might be ported to run on a high-end workstation based on a UNIX operating system, a Personal Digital Assistant (PDA) based on a Palm operating system, a low-end Internet appliance with a simple embedded operating system, or any other machine for user interface to the World Wide Web via the Internet. In theory, either the server software or the client software may even be converted to a hardware implementation. Communication links 50 may or may not include hubs, switches, routers, firewalls and other network elements used in or with Internet.

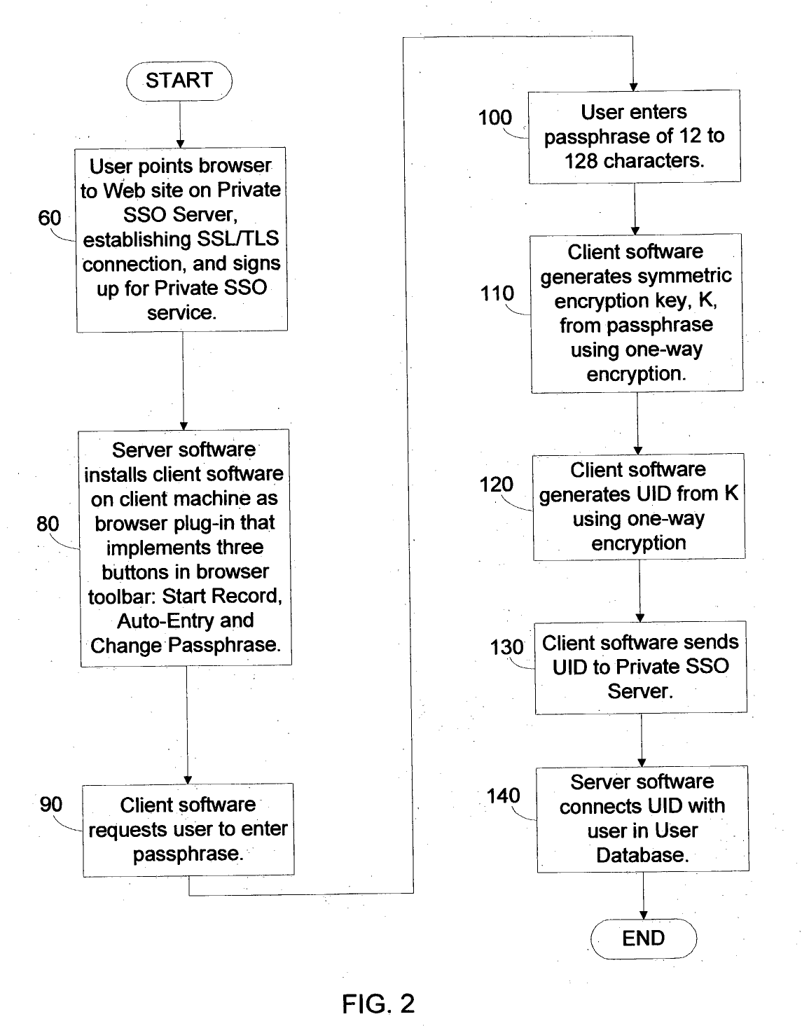

FIG. 2 shows the process by which a user signs up for the Private SSO service. In step 60, a user points a Web browser to the sign-up page of the Private SSO site running on server 10. Typically, this sign-up page would be implemented using secure hypertext transport protocol (HTTPS), which means that the client software in PC 30 communicates with the server software in server 10 using Secure Sockets Layer (SSL) protocol, which encrypts the two-way communication to protect privacy. (The latest version of SSL is also called Transport Layer Security, or TLS, protocol.) On this secure SSL connection, the user gives name, address, credit card number, etc., to pay for and receive the Private SSO service.

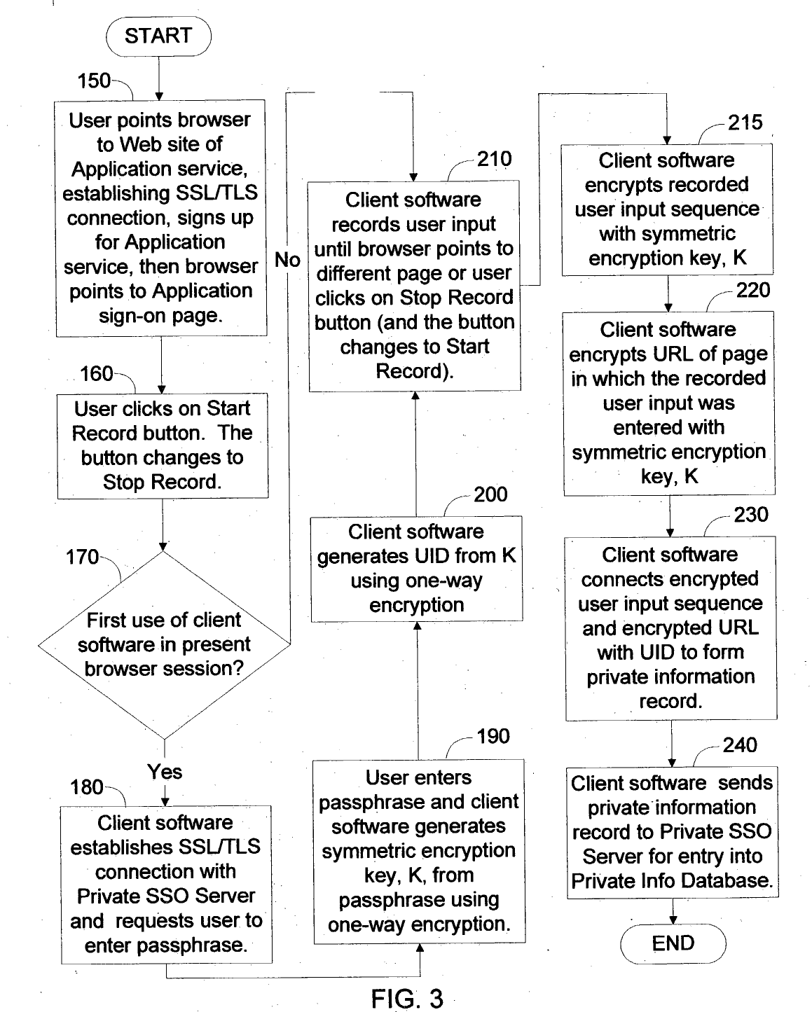

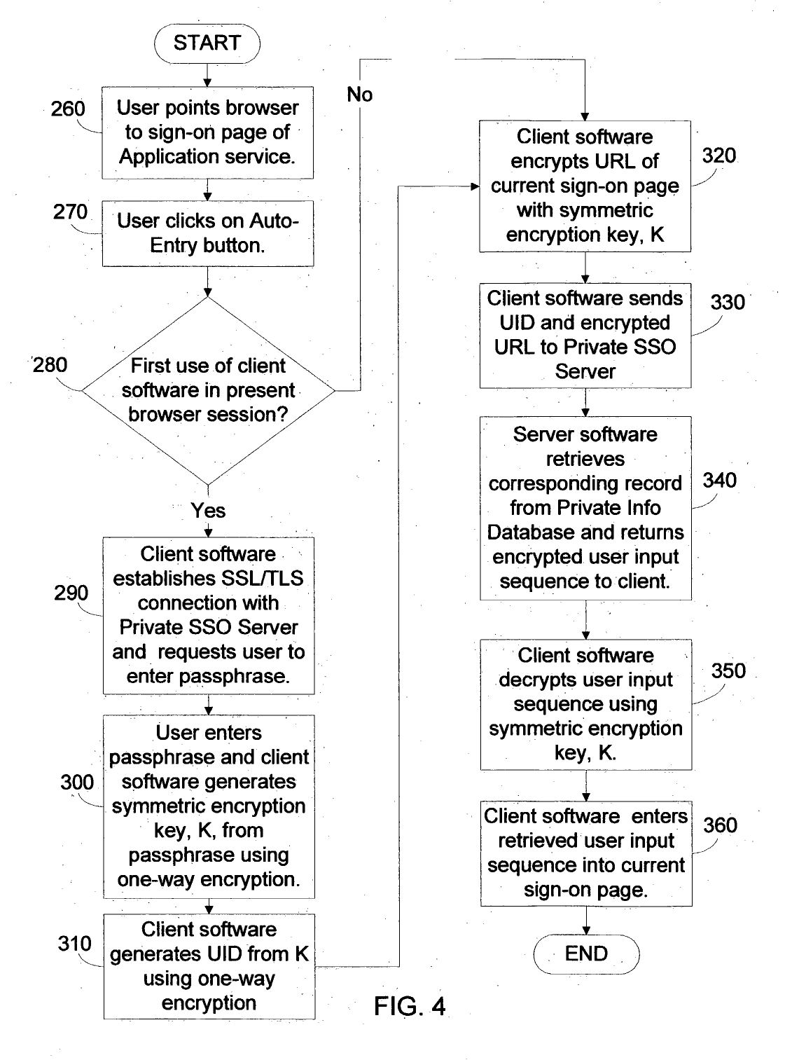

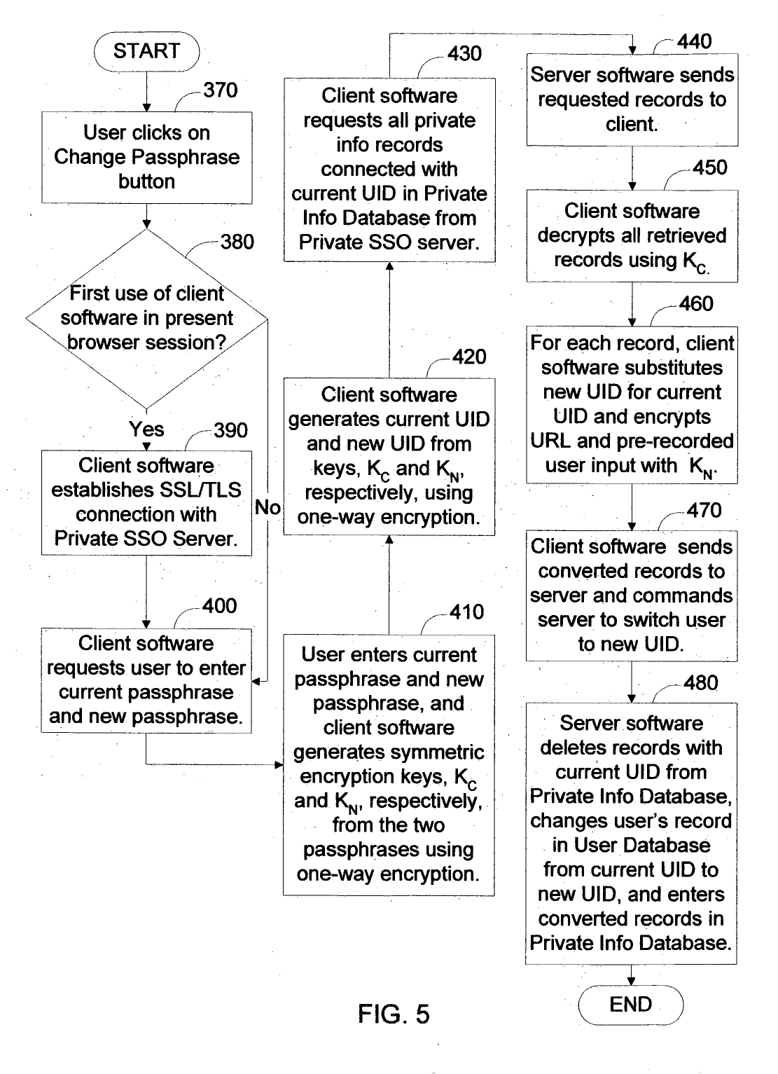

In step 80, the server software uses the same SSL connection to download and install client software on PC 30. In this preferred embodiment, the client software takes the form of a browser plug-in, which implements the function of three buttons in the browser toolbar: Start Record (described in FIG. 3), Auto-Entry (described in FIG. 4), and Change Passphrase (described in FIG. 5).

In step 90, the client software requests the user to enter a passphrase. A passphrase is defined to be any sequence of characters that the user can input to PC 30. In this preferred embodiment, the passphrase is restricted to a sequence of displayable characters, including the “blank” character, having a length of 12 to 128 characters, for reasons of practical convenience.

The user enters a passphrase in step 100. In step 110, the client software uses the passphrase to generate a symmetric encryption key, K, using one-way encryption (also called a secure hash function), such as SHA-1 (see “Secure Hash Standard”, Federal Information Processing Standards Publication 180-1, Apr. 17, 1995), which is used in this preferred embodiment. One-way encryption takes an input of arbitrary length—the passphrase, in this case—to generate an output key of fixed length—in this preferred embodiment, the 160-bit symmetric encryption key, K. One-way encryption possesses the following properties to the maximum possible degree: (1) the input is very hard to determine from the output, (2) it is very hard to find two different inputs that produce the same output, and (3) arbitrarily selected inputs produce outputs that appear to be randomly selected from a uniform distribution in the output domain.

In step 120, the client software uses one-way encryption again to generate a User ID (UID) from the symmetric encryption key, K. The client software sends the UID to Private SSO Server 10 in step 130, and the server software connects the UID with the user's identity by storing a record in a User Database in step 140. The User Database contains records comprising at least two fields: one for the UID and one with some unique indicator of the user's identity, which was established at the time of sign-up in step 60.

FIG. 3 shows a process for recording and storing private information associated with the sign-up page of a Web application service, such as electronic banking, Web e-mail, online shopping, etc. In step 150, a user points a Web browser to the sign-up page of the desired Web application service running on server 20. Typically, this sign-up page would be implemented using secure hypertext transport protocol (HTTPS) with Secure Sockets Layer (SSL) protocol, which encrypts the two-way communication to protect privacy. On this secure SSL connection, the user gives name, address, credit card number, etc., to pay for and receive the Web application service. After this sign-up, the user proceeds to the sign-on page of the selected service.

In step 160, the user clicks a mouse on “Start Record” button in the browser toolbar. The button is converted to a “Stop Record” so that recording of user input may be manually terminated later, if desired.

The client software starts running in PC 30 as part of the current browser session whenever it is installed or whenever the user clicks on any of the three buttons in the browser toolbar. In all four of these cases, described in FIGS. 2 through 5, the client software establishes an SSL connection with the server software in server 10, obtains a passphrase from the user, and computes the UID and the symmetric encryption key, K, from the passphrase. At the end of each of the processes described in FIGS. 2 through 5, the client software continues to be active, maintaining the SSL connection with server 10 and the current values of UID and K. The client software will become inactive when the browser session is terminated.

In step 170 of FIG. 3, the client software tests to determine whether or not the click on the “Start Record” button in step 160 is the first use of the client software in the current browser session. If “no”, then an SSL connection to Private SSO Server 10, the value of UID, and the value of K, are already available, and step 210 is the next step. If “yes”, then the client software must establish the connection, obtain a passphrase, and compute K and UID, in steps 180, 190, and 200.

In step 210, the client software records all user input until: (1) the browser moves to a different Web page, or (2) the user clicks on the “Stop Record” button. In either termination case, the “Stop Record” button changes to a “Start Record” to prepare for the next instance of capturing user input.

In steps 215 and 220, the client software encrypts the recorded user input sequence and the Uniform Resource Locator (or URL, an address that gives the location and name of any resource or file accessible via the Internet) of the page where the input was entered using a symmetric encryption algorithm and the key, K. A symmetric encryption algorithm applies a key to some data input to produce an encrypted form of the data, and the same key is applied to the encrypted data to regenerate the original data input. The symmetric encryption algorithm chosen for this preferred embodiment is defined by the Advanced Encryption Standard (AES). (See “Advanced Encryption Standard”, Federal Information Processing Standards Publication 197, Nov. 26, 2001. Note that K is truncated from 160 bits to 128 bits for use with AES.)

In steps 230 and 240, the client software connects these two associated pieces of encrypted information with the UID and sends the resulting record to Private SSO Server 10 for entry into the Private Info Database. The Private Info Database contains records comprising at least three fields: an encrypted user input sequence, an encrypted URL pointing to the page where the sequence was entered, and a UID designating a particular user.

A user input sequence recorded in the process of FIG. 3 may include keystrokes, mouse movements and clicks, touch-panel input, roller-ball input, and operation of any other input device that may be connected to PC 30 or other equivalent machines for browsing the Web.

A user makes use of recorded input by going to the sign-on page of a desired Web application service, such as electronic banking, as in step 260 of FIG. 4. In step 270, the user clicks on the “Auto-Entry” button in the browser toolbar. In step 280, the client software tests to determine whether or not the click on the “Auto-Entry” button is the first use of the client software in the current browser session. If “no”, then an SSL connection to Private SSO Server 10, the value of UID, and the value of K, are already available, and step 320 is the next step. If “yes”, then the client software must establish the connection, obtain a passphrase, and compute K and UID, in steps 290, 300, and 310.

In steps 320 and 330, the client software encrypts the URL of the current sign-on page with the symmetric encryption algorithm and the key, K, and combines the result with UID in a message to Private SSO Server 10. In step 340, server software in server 10, retrieves the record in the Private Info Database with corresponding fields that match the contents of the message from the client software. The encrypted user input sequence of this record is sent to the client software.

In steps 350 and 360, the client software decrypts the user input sequence with the symmetric encryption algorithm and the key, K, and automatically enters the result into the current sign-on page. Thus the user signs on to a desired Web application service with a single click on a button, without having to remember a username and password, or other required information.

With this new method, a single passphrase may provide access to numerous important and private Web services. Thus it is obvious good practice to change the passphrase regularly. Such a change process is shown in FIG. 5. In step 370, a user clicks on the “Change Passphrase” button in the browser toolbar. In step 380, the client software tests to determine whether or not the click on the “Change Passphrase” button is the first use of the client software in the current browser session. If “no”, then an SSL connection to Private SSO Server 10 is already available, and step 400 is the next step. If “yes”, then the client software must establish an SSL connection in step 390.

In steps 400 and 410, the client software obtains both the current and a new passphrase from the user, and computes the two keys, K_{C} and K_{N}, respectively, from the two passphrases using one-way encryption. In step 420, the client software computes the current UID from K_{C} and a new UID from K_{N} using one-way encryption again. Then, in step 430, the client software requests from the server software in Private SSO Server 10 all records in the Private Info Database that are connected with the current UID.

After the server software sends the requested records to the client software in step 440, the client software decrypts the records in step 450 using the symmetric encryption algorithm and the key, K_{C}. In step 460, the client software takes each decrypted record, substitutes the new UID for the current UID and encrypts again the user input sequence and URL fields using the symmetric encryption algorithm and K_{N}. In step 470, the client software sends the resulting converted records to server 10 along with a command to switch the user to the new UID. In step 480, the server software running in server 10 deletes all records containing the current UID from the Private Info Database, changes the user's record in the User Database from the current to the new UID, and enters the converted records into the Private Info Database.

### Conclusion and Variations

The preferred embodiment described above shows a new method of achieving a single sign-on to multiple Web services for user convenience, which overcomes significant disadvantages of the prior art. This new method does not require the vast majority of existing Web services to alter their present operations to cooperate in a system to identify and authorize users, which would complicate operations. A user does not need to be concerned about undesirable loss of privacy that might ensue from such cooperation. Furthermore, this new method does not require a user to maintain reliable local backup of important private information needed to access Web services, such as usernames and passwords. With the new method, a Private SSO Web service remembers all of a user's sign-on information for other Web services in an encrypted form that protects privacy.

Besides the preferred embodiment described above, the present invention has a number of additional uses and variations. Some examples are described below.

While signing-on to Web services is a key application of the new method, the new method may also be used for entry of repetitive information to any type of form on a Web page. For example, a user may wish to save and retrieve name, address, telephone number, e-mail address, credit card number, and credit card expiration date for entry into an ordering form of a favorite online shopping service. Thus a user has more convenient repeat purchasing without typing this information repetitively and without allowing the online shopping service to store the information in its own database.

The new single sign-on service may be enhanced in numerous ways. Because standard Web browsers use the location and name of local Hypertext Markup Language (HTML) files in the same way that they use URL's, a user may also use the new method to capture, store, and retrieve important personal documents, such as the user's medical history. A person skilled in the art of programming can readily extend the function of the client software to allow entry of an arbitrary user input sequence (or an already existing document, for example, a medical history) and to associate the input sequence with a blank Web form (an HTML document) stored on local PC 30. The location and name of the blank Web form (in place of a URL) would be encrypted and associated with an encrypted version of the arbitrary user input sequence. This associated pair would then be connected with the user's UID in a record of the Private Info Database. When the user goes to the blank Web form with a browser and clicks on “Auto-Entry”, the arbitrary user input sequence would be retrieved and displayed.

Consider another enhancement. It is not strictly necessary that a user's usernames and passwords for multiple Web services be recorded, one service at a time, according to the process illustrated in FIG. 3. A person skilled in the art of programming can readily extend the function of the client software to enable a user to directly enter a predetermined username and password, and the URL of the associated sign-on page, for each of multiple Web services into records of the Private Info database. This additional function is easy to implement and convenient for the user because the simple format of user input sequence required for sign-on to a great many Web services is: username<TAB>password<ENTER>.

Other available enhancements are improvements to verification of a user's identity. A person skilled in the art of programming can readily extend the function of the client software to do an additional check on a user's identity at the time of passphrase entry. The client software would check for the presence of some additional key stored in a portable memory device possessed by a user. This portable memory device might be a USB disk drive, a smart card, a magstripe card, a diskette, a CD-ROM, or any other device that could be read by PC 30. Another additional check that might be used is biometric identification. The client software would compare an immediate measurement of some physical characteristic of a user's body with a previous measurement of the same characteristic, which has been stored in a portable memory device possessed by the user. Systems for measuring fingerprints, face geometry, hand geometry, irises, etc. are readily available for use with standard PC's, such as PC 30.

Another possible enhancement to security is the use of computer-generated usernames and passwords whenever new Web services are added to a user's Private SSO service. Such character strings are known to be harder to guess than the strings typically chosen by users. A person skilled in the art of programming can readily add this function to the client software.

Because the sign-on pages of Web services may incur minor changes from time to time, the client software might be enhanced to do intelligent analysis of the user input sequence that is recorded by the process shown in FIG. 3. For example, instead of recording the display position of a mouse click input, the client software might analyze the HTML of the displayed Web page in order to record the particular entry field or button in which the mouse was clicked. A person skilled in the art of programming can readily make such enhancements to the client software.

In light of these numerous variations of the preferred embodiment, the scope of the present invention should be determined by the following claims.

1-15: (canceled)

16: A method for applying personal information in the use of Web services comprising:
a) verifying a user's identity,
b) associating one or more pairs of user input sequences and Uniform Resource Locators,
c) connecting said pairs with said user's verified identity,
d) storing said pairs connected with said user's identity in a database accessible on the public Internet,
e) retrieving each of said pairs when a user input sequence included in a particular pair is needed by said user for entry at an associated Uniform Resource Locator included in said particular pair, and
f) entering said user input sequence included in said particular pair into the Web page at said associated Uniform Resource Locator included in said particular pair,
whereby said user can easily recall any personal information that said user needs to access and use Web services with minimal maintenance burden for said user.

17: The method of claim 16 wherein associating one or more pairs of user input sequences and Uniform Resource Locators comprises associating one or more pairs of Web service sign-on procedures and Uniform Resource Locators.

18: The method of claim 16 wherein associating one or more pairs of user input sequences and Uniform Resource Locators comprises associating one or more pairs of Web service purchase order entry data and Uniform Resource Locators.

19: The method of claim 16 wherein associating one or more pairs of user input sequences and Uniform Resource Locators comprises associating one or more pairs of recorded user input sequences and Uniform Resource Locators.

20: The method of claim 16 wherein associating one or more pairs of user input sequences and Uniform Resource Locators comprises associating one or more pairs of directly entered user input sequences and Uniform Resource Locators.

21: The method of claim 16 wherein verifying a user's identity comprises entry of a passphrase.

22: The method of claim 16 wherein verifying a user's identity comprises checking data on a portable memory device possessed by said user.

23: The method of claim 16 wherein verifying a user's identity comprises comparing one or more of the physical characteristics of said user to biometric data stored on a portable memory device possessed by said user.

24: A method for applying personal information in the use of Web services comprising:
a) verifying a user's identity by entry of a passphrase,
b) encrypting said passphrase with one-way encryption to derive a User ID,
c) associating one or more pairs of user input sequences and Uniform Resource Locators,
d) encrypting said pairs with a key derived from said passphrase,
e) connecting the encrypted pairs with said User ID,
f) storing said encrypted pairs connected with said User ID in a database accessible on the public Internet,
g) retrieving each of said encrypted pairs when a user input sequence included in a particular encrypted pair is needed by said user for entry at an associated Uniform Resource Locator included in said particular encrypted pair,
h) decrypting said particular encrypted pair with said key derived from said passphrase, and
i) entering said user input sequence included in said particular encrypted pair into the Web page at said associated Uniform Resource Locator included in said particular encrypted pair,
whereby said user can easily recall any personal information that said user needs to access and use Web services with minimal maintenance burden and a high degree of privacy for said user.

25: The method of claim 24 wherein associating one or more pairs of user input sequences and Uniform Resource Locators comprises associating one or more pairs of Web service sign-on procedures and Uniform Resource Locators.

26: The method of claim 24 wherein associating one or more pairs of user input sequences and Uniform Resource Locators comprises associating one or more pairs of Web service purchase order entry data and Uniform Resource Locators.

27: The method of claim 24 wherein associating one or more pairs of user input sequences and Uniform Resource Locators comprises associating one or more pairs of recorded user input sequences and Uniform Resource Locators.

28: The method of claim 24 wherein associating one or more pairs of user input sequences and Uniform Resource Locators comprises associating one or more pairs of directly entered user input sequences and Uniform Resource Locators.

29: The method of claim 24 further including verifying said user's identity by checking data on a portable memory device possessed by said user.

30: The method of claim 24 further including verifying said user's identity by comparing one or more of the physical characteristics of said user to biometric data stored on a portable memory device possessed by said user.

31: A computing system for applying personal information in the use of Web services comprising:
a) a user interface means for enabling a user to browse the World-Wide Web,
b) a server means for storing and retrieving personal information,
c) a network means for digital communications between said user interface means and said server means, and between said user interface means and a Web service,
d) a first means for verifying said user's identity,
e) a second means for associating one or more pairs of user input sequences and Uniform Resource Locators,
f) a third means for connecting said pairs with said user's verified identity,
g) a fourth means for storing said pairs connected with said user's identity in a database accessible on the public Internet,
h) a fifth means for retrieving each of said pairs when a user input sequence included in a particular pair is needed by said user for entry at an associated Uniform Resource Locator included in said particular pair, and
i) a sixth means for entering said user input sequence included in said particular pair into the Web page at said associated Uniform Resource Locator included in said particular pair,
whereby said user can easily recall any personal information that said user needs to access and use Web services with minimal maintenance burden for said user.

32: The computing system of claim 31 wherein said first means of verifying a user's identity comprises means for entering a passphrase.

33: The computing system of claim 31 wherein said first means of verifying a user's identity comprises means for checking data on a portable memory device possessed by said user.

34: The computing system of claim 31 wherein said first means of verifying a user's identity comprises means for comparing one or more of the physical characteristics of said user to biometric data stored on a portable memory device possessed by said user.

35: The computing system of claim 31 wherein said second means for associating one or more pairs of user input sequences and Uniform Resource Locators comprises means for associating one or more pairs of Web service sign-on procedures and Uniform Resource Locators.

36: The computing system of claim 31 wherein said second means for associating one or more pairs of user input sequences and Uniform Resource Locators comprises means for associating one or more pairs of Web service purchase order entry data and Uniform Resource Locators.

37: The computing system of claim 31 wherein said second means for associating one or more pairs of user input sequences and Uniform Resource Locators comprises means for associating one or more pairs of recorded user input sequences and Uniform Resource Locators.

38: The computing system of claim 31 wherein said second means for associating one or more pairs of user input sequences and Uniform Resource Locators comprises means for associating one or more pairs of directly entered user input sequences and Uniform Resource Locators.
